(19) United States
(12) Patent Application Publication
(10) Pub. No.: US 2026/0307415 A1
(43) Pub. Date: Oct. 8, 2026

(54) SUBLIMATION PRINTING TRANSFER PAPER HAVING TACKY PROPERTIES

(71) Applicant: AHLSTROM OYJ, Espoo (FI)

(72) Inventors: Alexandre DECOMPTE, Colombe (FR); Marion PASTRELLO, La Batie Montgascon (FR); Lucie BOIRON, Saint Egreve (FR)

(21) Appl. No.: 19/484,975

(22) PCT Filed: May 22, 2024
(86) PCT No.: PCT/EP2024/064066

§ 371 Date: Nov. 17, 2025

(30) Foreign Application Priority Data
May 22, 2023 (EP) 23174539.9

(51) Int. Cl. B41M 5/392; B41M 5/025; B41M 5/41; D06P 3/52; D06P 5/28; D21H 19/10

(52) U.S. Cl. CPC B41M 5/392; B41M 5/0256; B41M 5/41; D06P 3/52; D06P 5/004; D21H 19/10; B41M 2205/02

(57) ABSTRACT

The present invention relates to a sublimation printing transfer paper comprising a base substrate and a partially-saponified polyvinyl alcohol (PVOH) based coating on one side of said base substrate, wherein the partially-saponified PVOH has a saponification degree of 70 to 85%, as well as the method of preparing said sublimation printing transfer paper, and the use of said sublimation printing transfer paper in a sublimation printing transfer process.

### TECHNICAL FIELD

The present invention relates to a sublimation printing transfer paper having tacky properties as well as the method of preparing said sublimation printing transfer paper, and the use of said sublimation printing transfer paper in a sublimation printing transfer process.

### BACKGROUND ART

The sublimation printing transfer process is a well-known technique to impart brilliant colours and high resolution images onto various printing substrates. Such various printing substrates may be wearable and non-wearable fabrics, such as shirts, covers, tote bags and mousepads, flags, and/or harder articles such as ceramic crockery, mobile phone covers, metal plates, tiles, etc. The sublimation printing transfer process is an indirect printing process. This indirect printing process comprises a first step of printing with sublimable inks a transferable image or a transferable print on a transfer sheet using a conventional printing process, such as digital or ink-jet printing. In a second step, the transferable image is transferred to the printing substrate in a sublimation printing step, said sublimation printing step implementing heat and pressure. During the sublimation printing step, the sublimable inks and/or dyes constituting the transferable image on the transfer sheet sublimate and are transferred onto the printing substrate resulting in a transferred print or a transferred image on the printing substrate. Typically, the transferable image is generally the mirror image of the transferred image.

During sublimation printing with a transfer sheet it is important to maintain a good adhesion between the sublimation printing transfer paper and the printing substrate, said printing substrate being most of the time disposed on a moving wire. Failure to maintain such an adhesion between the sublimation printing transfer paper and the printing substrate can cause the transfer sheet to slip during sublimation printing, resulting in an improper transfer of print. This is a particular problem when the printing substrate is smooth and slippery, e.g. a polyester fabric. Improper transfer of print usually manifests itself in a poor transferred image quality. One commonly observed phenomenon is ghosting or duplication of print, wherein transferred image features are reproduced twice with a lateral and/or longitudinal shift in-between or are missing.

To avoid such printing artefacts and to maintain a high transferred image quality, manufacturers have developed tacky sublimation printing transfer papers which have a favourable degree of adhesion to the printing substrates. Such tacky properties are typically achieved by means of a thermoplastic latex-based coating on the transferable image-bearing side of the sublimation printing transfer paper as presented for example in WO 2016/074671 or WO 2018/091179. Common thermoplastic latex-based coatings include polyolefins, polyacrylates, acrylics, polylactates, polystyrenes, polyethyleneterephthalates, polyvinylchlorides, polyetherketones, celluloid, or polyamides, and their copolymers.

The thermoplastic latex-based coatings are hydrophobic and inhibit the permeation of water into the paper underneath, thus leading to an increase in the drying time of transferable print on the sublimation printing transfer paper. Such slow drying times typically hinder fast and high throughput printing leading to limited printing efficiency. It has further to be noted that a slow drying time may also provoke some bleeding of the inks on the paper substrate and thus the definition of the transferable print on the printing substrate can be compromised. Moreover, the latex-based coatings typically limit the recyclability of the sublimation printing transfer papers due to the poor water-solubility of the components. Recycling by re-pulping therefore only has limited yields on conventional sublimation printing transfer papers as latex compounds will remain on the fibres and will therefore not be reusable. Whilst sublimation printing transfer papers without a latex-based coating exhibit improved drying times of the transferable prints and recyclability, they lack tack and are therefore prone to improper transfer of print resulting in a poorer transferred image quality on the printing substrate and more particularly when this printing substrate is moving on a wire during the sublimation printing process.

### Problem to be Solved

The present invention is therefore directed towards the provision of a sublimation printing transfer paper having tacky properties with improved drying time and recyclability without compromising on the transferred image quality.

### SUMMARY OF THE INVENTION

The present invention solves the problems of the prior art by the following means.

In a first aspect, the present invention relates to a sublimation printing transfer paper comprising a base substrate and a partially-saponified polyvinyl alcohol (PVOH) based coating on one side of said base substrate, wherein the partially-saponified PVOH has a saponification degree of 70 to 85%.

In a second aspect, the present invention relates to a method of preparing the sublimation printing transfer paper of the first aspect, wherein the method comprises applying the coating onto the base substrate by online or offline coating methods.

In a third aspect, the present invention relates to a use of the sublimation printing transfer paper of the first aspect in a sublimation printing transfer process.

In a fourth aspect, the present invention relates to a printed sublimation printing transfer paper, comprising the sublimation printing transfer paper of the first aspect and at least one transferable print on the coating.

In a fifth aspect, the present invention relates to a method of preparing a printed sublimation printing transfer paper, wherein the method includes a step of ink-jet printing on the coating of the sublimation printing transfer paper of the first aspect.

In a sixth aspect, the present invention relates to a method of decorating a printing substrate, in which the transferable print of the printed sublimation printing transfer paper of the fourth aspect is transferred by sublimation onto the printing substrate.

### BRIEF DESCRIPTION OF THE DRAWINGS

FIG. 1 depicts transferred prints obtained using the sublimation printing transfer papers of Example B.

FIG. 2 depicts the results of the recyclability potential assessment of Example C.

### DETAILED DESCRIPTION OF THE INVENTION

### Sublimation Printing Transfer Paper

In the first aspect, the present invention relates to a sublimation printing transfer paper comprising a base substrate and a partially-saponified polyvinyl alcohol (PVOH) based coating on one side of said base substrate, wherein the partially-saponified PVOH has a saponification degree of 70 to 85%.

The term “base substrate” as used herein, may be defined as an article onto which a coating can be disposed. The base substrate is most typically a sheet, such as a sheet of paper. Such a sheet typically has two sides which are characterised by the height and width of the sheet.

The term “partially-saponified polyvinyl alcohol (PVOH) based coating” as used herein, may be defined as a coating based on partially-saponified polyvinyl alcohol (PVOH) which is disposed on the base substrate. Said coating is continuous, i.e. substantially void of holes and islands which would result in uncoated regions on the substrate. The terms “partially-saponified polyvinyl alcohol (PVOH) based coating” and “partially-saponified PVOH-based coating” are used synonymously herein. Unless specified otherwise “the coating” as used herein may also be understood as “the partially-saponified PVOH-based coating”. Unless specified otherwise “the partially-saponified PVOH” as used herein refers to the partially-saponified PVOH of the partially-saponified PVOH-based coating.

The term “partially-saponified PVOH” as used herein refers to a polyvinyl alcohol that has been obtained by partial saponification of polyvinyl acetate (PVAC). Typically, this is achieved by partial hydrolysis under acid or base catalysis. Partially-saponified PVOH thus comprises hydroxy groups as well as acetate groups. Typically, partially-saponified PVOH has a molecular formula of (C₄H₆O₂)ₙ(C₂H₄O)ₘ. Partially-saponified PVOH is typically characterised by the saponification degree.

The term “saponification degree” as used herein has its conventional meaning as known and used in the art. The following qualification of the term is merely for illustrative purposes and not intended to be limiting. The term “saponification degree” as used herein may be used synonymously with the terms “saponification rate”, “hydrolysis degree” and “hydrolysis rate”. The saponification degree quantifies the degree of saponification from PVAC to PVOH as a molar percentage. A saponification degree of 0% corresponds to a PVAC substantially comprising no hydroxy groups, i.e. 0 mol % hydroxy groups and 100 mol % acetate groups. A saponification degree of 100% corresponds to PVOH substantially comprising no acetate groups, i.e. 0 mol % acetate groups and 100 mol % hydroxy groups. A saponification degree of 50% corresponds to a partially-saponified PVOH comprising half acetate groups and half hydroxy groups, i.e. 50 molo hydroxy groups and 50 mol % acetate groups. Generally, a saponification degree of (SD) % corresponds to a partially-saponified PVOH comprising (SD) mol % hydroxy groups and [100-(SD)] mol % acetate groups.

The partially-saponified PVOH-based coating is disposed on one side of the base substrate. This partially-saponified PVOH coating can be in direct contact with the base substrate or an intermediate layer can be configured between the partially-saponified PVOH coating and the based substrate. The partially-saponified PVOH-based coating is aimed at receiving the transferable print and is thus an outermost layer of the sublimation printing transfer paper.

The present inventors have unexpectedly found that a sublimation printing transfer paper comprising a base substrate and a partially-saponified polyvinyl alcohol (PVOH) based coating on one side of said base substrate, wherein the partially-saponified PVOH has a saponification degree of 70 to 85%, promotes a high transferred image quality upon sublimation printing, whilst simultaneously exhibiting faster drying times of the transferable print and being recyclable.

The present inventors submit that a saponification degree of 70 to 85% is essential to obtaining a high transferred image quality, fast drying time, and good recyclability.

If the saponification degree is below 70%, the transferred image quality depreciates. Without wishing to be bound by theory, the present inventors submit that the saponification degree expresses a ratio of hydrophilic hydroxy groups to hydrophobic acetate groups. Whilst the acetate groups give the partially-saponified PVOH tacky properties, the hydroxy groups give the partially-saponified PVOH hydrophilic properties. It is believed that below a saponification degree of 70%, tacky properties become too high leading to too strong adhesion between the sublimation printing transfer paper and the printing substrate making peeling off after sublimation printing difficult. This can lead to fibre tear and/or delamination of the transfer sheet on the printing substrate, thus depreciating the transferred image quality. If the saponification degree is above 85%, the transferred image quality also depreciates. It is believed that above a saponification degree of 85%, the tacky properties become too low leading to insufficiently strong adhesion between the sublimation printing transfer paper and the printing substrate during the transfer of the print on the printing substrate by sublimation. The sublimation printing transfer paper is thus prone to slipping, leading to an improper transfer of print, e.g. ghosting or duplication, and a poor transferred image quality.

The transferred image quality may also include the printing resolution or sharpness of the transferred image. The term “resolution” as used herein has its ordinary meaning as used in the art, i.e. it corresponds to the definition of the lines and the details of a print. When the saponification degree is below 70%, the resolution of the transferable print decreases, thereby lowering the resolution of the transferred image and thus the transferred image quality. It is believed that below a saponification degree of 70%, hydrophilic properties become too low and the coating becomes too hydrophobic. Due to the hydrophobicity of the coating, the transferable print resolution is poor as the water, which is the vector of the ink, forms a film on the coating and does not rapidly permeate into the paper. This can cause the ink to spread during drying, also known as ink spreading or line bleeding, and can thus cause deformation of the transferable print. When the saponification degree is above 85%, the resolution of the transferable print also decreases, leading to a similar depreciation in the transferred image quality. It is believed that above a saponification degree of 85%, hydrophilic properties become too high, and the coating become too hydrophilic. Thus, the water vector of the ink preferentially stays in the PVOH causing it to swell, which may also lead to bleeding effects on the transferable image.

If the saponification degree is below 70%, the ink drying time increases. It is believed that below a saponification degree of 70%, hydrophilic properties become too low and the coating becomes too hydrophobic. As mentioned above, this causes the water to form a film on the coating and it does not rapidly permeate into the paper. If the saponification degree is above 85%, the ink drying time increases. It is believed that above a saponification degree of 85%, hydrophilic properties become too high and the coating become too hydrophilic. Thus, the water vector in water-based inks preferably remains in the coating causing it to swell and it does not rapidly enter into the paper leading to increased drying times. Increased drying times may lead to further bleeding effects on the transferable image and increased processing times, lowering efficiency.

If the saponification degree is below 70%, the recyclability decreases. It believed is a that below saponification degree of 70%, hydrophilic properties become too low and the coating becomes partially insoluble in water. Due to said partial insolubility, parts of the sublimation printing transfer paper cannot be recovered by re-pulping, thereby limiting recyclability.

Thus, it is believed that a saponification degree of 70 to 85% strikes a favourable balance of tackiness and hydrophilicity which promotes a high transferred image quality, fast drying times, and good recyclability.

In a preferred embodiment, the partially-saponified PVOH is hydrosoluble. In one embodiment, the partially-saponified PVOH is hydrosoluble at 30° C. In one embodiment, the partially-saponified PVOH is hydrosoluble upon heating to 90° C.

In one embodiment, the partially-saponified PVOH has a viscosity at 20° C. of a 4% aqueous solution of 3 to 50 mPa×s, preferably 3 to 20 mPa×s, when measured according to DIN 53015.

In a preferred embodiment of the first aspect of the present invention, the partially-saponified PVOH has a saponification degree of 72 to 82%, more preferably 73 to 80%.

In a particularly preferred embodiment, the partially-saponified PVOH has a saponification degree of 73-75%. It is observed that when the saponification degree is 73-75%, particularly fast dryings times can be achieved whilst a high transferred image quality and good recyclability can be achieved. It is believed that the high transferred image quality is linked to optimal tack and peel off properties.

In a preferred embodiment of the first aspect of the present invention, the coating is substantially latex-free. According to the present invention, substantially latex-free means an amount of latex-containing components below 5 wt %, more preferably below 2 wt %, based on the total weight of the coating composition. In a preferred embodiment, the sublimation printing transfer paper is substantially latex-free.

The term “latex” as used herein has its conventional meaning in the art and preferably refers to dispersions of synthetic polymer materials, such as synthetic thermoplastic and/or synthetic thermosetting polymers. Such thermoplastic and/or thermosetting polymers may include but are not limited to polyolefins, polyacrylates, acrylics, polylactates, polystyrenes, polyethyleneterephthalates, polyvinylchlorides, polyetherketones, celluloid, or polyamides, and their copolymers.

In a preferred embodiment of the first aspect of the present invention, the sublimation printing transfer paper is recyclable according to the EN 13430 standard. In some embodiments, the recyclability is related to the amount of fibres recovered by mass, after repulping and classification through a screen. The amount of recovered fibres may vary but has to be above 70, preferably above to 75 wt %. Then, from what has been recovered (rejects are eliminated), the fibres must be reusable in a paper making process.

In a preferred embodiment of the first aspect of the present invention, the sublimation printing transfer paper has a Gurley porosity of at least 1,000 s/100 cc, for example between 1,000 s/100 cc and 10,000 s/100 cc or more, preferably 10,000 s/100 cc or more, such as preferably between 10,000 s/100 cc and 500,000 s/100 cc, more preferably between 10,000 s/100 cc and 200,000 s/100 cc, even more preferably between 20,000 s/100 cc and 180,000 s/100 cc and most preferably between 40,000 s/100 cc and 170,000 s/100 cc, wherein the Gurley porosity is measured according to ISO 5636-5.

In a preferred embodiment of the first aspect of the present invention, the sublimation printing transfer paper has a Cobb (60 s) value of more than 20 g/m², preferably more than 25 g/m², even more preferably of 30 to 60 g/m², wherein the Cobb (60 s) value is measured according to ISO 535:2014.

In a preferred embodiment of the first aspect of the present invention, the sublimation printing transfer paper has a tackiness of 0.4 to 1.2 N/2.5 cm, preferably 0.6 to 0.8 N/2.5 cm, when measured according to the Finat FTM2 standard. Test conditions according to this standard, include a speed of 300 mm/min at an angle of 90°. The paper samples are 25 mm width and at least 150 mm length and prepared by putting in contact the tacky side of the paper against polyester fabric at a temperature of 210° C. for 60 seconds. The pressure should be sufficient to ensure a good contact between the paper and the fabric.

In a preferred embodiment of the first aspect of the present invention, the sublimation printing transfer paper has a basis weight of 60 to 130 g/m², preferably of 80 to 110 g/m², wherein the basis weight is measured according to ISO 536.

In a preferred embodiment of the first aspect of the present invention, the sublimation printing transfer paper has
(I) a Gurley porosity of at least 1,000 s/100 cc, for example between 1,000 s/100 cc and 10,000 s/100 cc or more, preferably 10,000 s/100 cc or more, such as preferably between 10,000 s/100 cc and 500,000 s/100 cc, more preferably between 10,000 s/100 cc and 200,000 s/100 cc, even more preferably between 20,000 s/100 cc and 180,000 s/100 cc and most preferably between 40,000 s/100 cc and 170,000 s/100 cc, wherein the Gurley porosity is measured according to ISO 5636-5, and
(II) a Cobb (60 s) value of more than 20 g/m², preferably more than 25 g/m², even more preferably of 30 to 60 g/m², wherein the Cobb (60 s) value is measured according to ISO 535:2014. It is observed that when the Gurley porosity and the Cobb (60 s) value are in the above range, particularly fast drying times can be achieved, likely due to the relative hydrophilicity of the coating and the base substrate.

In a preferred embodiment of the first aspect of the present invention, the sublimation printing transfer paper has one or more of the following properties
(I) a Gurley porosity of at least 1,000 s/100 cc, for example between 1,000 s/100 cc and 10,000 s/100 cc or more, preferably 10,000 s/100 cc or more, such as preferably between 10,000 s/100 cc and 500,000 s/100 cc, more preferably between 10,000 s/100 cc and 200,000 s/100 cc, even more preferably between 20,000 s/100 cc and 180,000 s/100 cc and most preferably between 40,000 s/100 cc and 170,000 s/100 cc, wherein the Gurley porosity is measured according to ISO 5636-5;
(II) a Cobb (60 s) value of more than 20 g/m², preferably more than 25 g/m², even more preferably of 30 to 60 g/m², wherein the Cobb (60 s) value is measured according to ISO 535:2014;
(III) a tackiness of 0.4 to 1.2 N/2.5 cm, preferably 0.6 to 0.8 N/2.5 cm, when measured according to the Finat FTM2 standard;
(IV) a basis weight of 60 to 130 g/m², preferably of 80 to 110 g/m², wherein the basis weight is measured according to ISO 536;
and wherein the features (I) to (IV) above may be taken on their own or be combined with one another. For instance, in some embodiments, the sublimation printing transfer paper may have the features (I) and (III); (I) and (IV); (II) and (III); (II) and (IV); (III) and (IV); (I), (II), and (III); (I), (II), and (IV); (I), (III), and (IV); (II), (III), and (IV); and (I), (II), (III), and (IV); respectively.

In a preferred embodiment of the first aspect of the present invention, the base substrate comprises 80 to 100 wt % natural cellulosic fibres and 0 to 20 wt % filler, based on the weight of the base substrate.

The term “fibre” as used herein refers to a material form characterized by an extremely high ratio of length to diameter. Generally, cellulose fibres have a very broad range of diameters and length based on fibre type and source of fibre. The average length of a wood pulp fibre as preferably used in the present invention is typically in the range of between from 0.3 mm to 3.5 mm, preferably from 0.3 mm to 3.0 mm, more preferably from 0.8 mm to 2.5 mm and even more preferably from 1.0 mm to 2.0 mm. The diameter of a wood pulp fibre is typically in the range of from 10 μm to 40 μm, preferably from 15 μm to 35 μm and more preferably from 20 μm to 30 μm. The aspect ratio (ratio of fibre length to fibre diameter) of a wood pulp fibre is therefore typically in the range of from 7.5 to 350, preferably from 7.5 to 300, more preferably from 10 to 200 and even more preferably from 20 to 150. The terms “fibre” and “filament” can be used interchangeably for the purposes of the present invention unless otherwise specifically indicated. The term “natural cellulosic fibres” as used herein refers to cellulose fibres from natural sources such as woody plants including deciduous and coniferous trees or non-woody plants including cotton, flax, esparto grass, kenaf, sisal, abaca, milkweed, straw, jute, hemp and bagasse. The natural cellulosic fibres form a partially crystalline material comprising a crystallized fraction with the crystalline form of Cellulose I comprising all-parallel-oriented cellulose chains.

The term “filler” as used herein, refers to further components in the base substrate other than the natural cellulosic fibres. In one embodiment, the filler is one or more selected from talc, calcium carbonate, kaolin clay, titanium dioxide and mixtures thereof

Preferably, the base substrate comprises 81 to 100 wt % natural cellulosic fibres and 0 to 19 wt % filler, more preferably 82 to 100 wt % natural cellulosic fibres and 0 to 18 wt % filler, more preferably 83 to 100 wt % natural cellulosic fibres and 0 to 17 wt % filler, more preferably 84 to 100 wt % natural cellulosic fibres and 0 to 16 wt % filler, more preferably 85 to 100 wt % natural cellulosic fibres and 0 to 15 wt % filler, more preferably 86 to 100 wt % natural cellulosic fibres and 0 to 14 wt % filler, more preferably 87 to 100 wt % natural cellulosic fibres and 0 to 13 wt % filler, more preferably 88 to 100 wt % natural cellulosic fibres and 0 to 12 wt % filler. Even more preferably fillers are present in the base substrate in an amount of 10 to 15 wt %.

In one embodiment of the first aspect of the present invention, the base substrate has a Gurley porosity below 1000 s/100 cc, preferably below 500 s/100 cc, and more preferably below 100 s/100 cc, wherein the Gurley porosity is measured according to ISO 5636-5.

In one embodiment of the first aspect of the present invention, the base substrate has a Cobb (60 s) value of more than 20 g/m², preferably more than 25 g/m², even more preferably between 30 and 60 g/m², wherein the Cobb (60 s) value is measured according to ISO 535:2014.

In one embodiment of the first aspect of the present invention, the base substrate has
(i) a Gurley porosity below 1000 s/100 cc, preferably below 500 s/100 cc, and more preferably below 100 s/100 cc, wherein the Gurley porosity is measured according to ISO 5636-5; and
(ii) a Cobb (60 s) value of more than 20 g/m², preferably more than 25 g/m², even more preferably between 30 and 60 g/m², wherein the Cobb (60 s) value is measured according to ISO 535:2014.

In one embodiment of the first aspect of the present invention, the partially-saponified PVOH is contained in the coating in an amount of 60 to 100 wt %, based on the total weight of the coating.

Preferably, the partially-saponified PVOH is contained in the coating in an amount of 62 to 100 wt %, more preferably 64 to 100 wt %, more preferably 68 to 100 wt %, more preferably 70 to 100 wt %, more preferably 72 to 100 wt %, more preferably 74 to 100 wt %, more preferably 76 to 100 wt %, more preferably 78 to 100 wt %, more preferably 80 to 100 wt %, more preferably 82 to 100 wt %, more preferably 84 to 100 wt %, more preferably 86 to 100 wt %, more preferably 88 to 100 wt %, more preferably 90 to 100 wt %, more preferably 92 to 100 wt %, more preferably 94 to 100 wt %, more preferably 96 to 100 wt %, more preferably 98 to 100 wt %, and even more preferably 99 to 100 wt %.

In one embodiment of the first aspect of the present invention, the coating may contain 0 to 40 wt % of co-binders, based on the total weight of the coating.

The term “co-binders” are used herein refers to further component in the coating other than the partially-saponified PVOH. Said co-binders are preferably chosen in material and/or in quantity such that the favourable balance of tackiness and hydrophilicity of the partially-saponified PVOH-based coating is not substantially affected.

Preferably, the coating contains 0 to 38 wt % of co-binders, more preferably 0 to 36 wt %, more preferably 0 to 34 wt %, more preferably 0 to 32 wt %, more preferably 0 to 30 wt %, more preferably 0 to 28 wt %, more preferably 0 to 26 wt %, more preferably 0 to 24 wt %, more preferably 0 to 22 wt %, more preferably 0 to 20 wt %, more preferably 0 to 18 wt %, more preferably to 16 wt %, more preferably 0 to 14 wt %, more preferably 0 to 12 wt %, more preferably 0 to 10 wt %, more preferably 0 to 8 wt %, more preferably 0 to 6 wt %, more preferably 0 to 4 wt %, more preferably 0 to 2 wt %, and even more preferably 0 to 1 wt %.

Preferably, the co-binders are selected from starch and derivatives thereof, fully-saponified PVOH, carboxymethyl cellulose (CMC) and other cellulosic derivates, alginates, latexes, and mixtures of any of the foregoing.

Starch derivatives are chemical derivates of starch and may include but are not limited to dextrin, alkaline modified starch, bleached starch, oxidized starch, enzyme-treated starch, monostarch phosphate, distarch phosphate, acetylated starch, hydroxypropylated starch, hydroxyethyl starch, starch sodium octenyl succinate, starch aluminium octenyl succinate, cationic starch, and carboxymethylated starch, and mixtures of any of the foregoing. Where used, starch derivatives are not limited as long as they are hydrosoluble.

Cellulosic derivatives are chemical derivates of cellulose and may include but are not limited to alkylated cellulose, such as methylated, ethylated and propylated, hydroxypropylated cellulose, sulfonated cellulose, nitrated cellulose, acetylated cellulose, oxidised cellulose, and crosslinked cellulose. Where used, cellulosic derivatives are not limited as long as they are hydrosoluble.

Preferably, to further improve recyclability, the co-binders are hydrosoluble co-binders and are selected from starch and derivatives thereof, fully-saponified PVOH, carboxymethyl cellulose (CMC) and other cellulosic derivates, alginates, and mixtures of any of the foregoing.

When the co-binders include fully-saponified PVOH, said fully-saponified PVOH is not considered in the determination of saponification degree of the partially-saponified PVOH. For instance, a coating may comprise 96 wt % of a partially-saponified PVOH with a saponification degree of 73% and 4 wt % of fully-saponified PVOH as a co-binder.

In one embodiment of the first aspect of the present invention, the coating contains 0 to 20 wt % pigments, based on the total weight of the coating.

Preferably, the coating contains 0 to 18 wt % of pigments, more preferably 0 to 16 wt %, more preferably 0 to 14 wt %, more preferably 0 to 12 wt %, more preferably 0 to 10 wt %, more preferably 0 to 8 wt %, more preferably 0 to 6 wt %, more preferably 0 to 4 wt %, more preferably 0 to 2 wt %, and even more preferably 0 to 1 wt %.

Preferably, the pigments are selected from kaolin clay, calcium carbonate, silica, talc, titanium dioxide, and mixtures of any of the foregoing.

Preferably, the co-binder and the pigments amounts do not exceed 40 wt % of the coating composition in order to keep the tack properties, more particularly the pigments may represent at most 20 wt % of the coating composition.

In one embodiment of the first aspect of the present invention, the coating has a coatweight on the side of the base substrate of 1 to 10 g/m² by dry weight.

Preferably, the coating has a coatweight on the side of the base substrate of 1 to 5 g/m², more preferably of 2 to 3 g/m² by dry weight.

In a preferred embodiment, the coating is in direct contact with the base substrate. In an alternative embodiment, additional layers are configured between the base substrate and the coating.

When an additional layer is disposed between the base substrate and the coating, this additional layer may serve as a primer to improve the surface of the base substrate to smoothen it and also decrease the coatweight of the coating. Typically, this additional layer can comprise fillers and one or more binder. The fillers can be chosen among delaminated kaolin or calcined kaolin and the binder can be chosen among starch or CMC. The coatweight of this additional layer is typically comprised between 1 and 5 g/m².

In a preferred embodiment, an anti-back-gazing layer can be disposed on the side of the base substrate opposite to the side holding the partially-saponified PVOH layer. This anti-back-gazing layer is aimed at preventing the sublimation of the sublimable ink forming the transferable print through the paper and not in the direction of the printing substrate. This anti-back-gazing layer can be made of fully-saponified PVOH, carboxymethyl cellulose (CMC) and other cellulosic derivates, alginates, and mixtures of any of the foregoing.

### Method of Preparing Sublimation Printing Transfer Paper

In the second aspect, the present invention relates to a method of preparing the sublimation printing transfer paper of the first aspect, wherein the method comprises applying the coating onto the base substrate by online or offline coating methods.

Preferably, the online or offline coating methods include but are not limited to size-press, metering size-press, twin coating, metering coating, rod coating, blade coating, airblade coating, curtain coating, film press, heliogravure, rotogravure, spray coating or transfer coating.

### Use of Sublimation Printing Transfer Paper

In the third aspect, the present invention relates to the use of the sublimation printing transfer paper of the first aspect in a sublimation printing transfer process.

The sublimation printing transfer process may be understood as a technique which comprises a first step of printing a transferable image or a transferable print on the sublimation printing transfer paper using a conventional printing process, such as digital or ink-jet printing. In a second step, the transferable image is transferred to the printing substrate in a sublimation printing step. During the sublimation printing step, the sublimable dyes and/or inks constituting the transferable image on the sublimation printing transfer paper are transferred onto the printing substrate resulting in a transferred print or a transferred image on the printing substrate. Typically, the transferable image is the mirror image of the transferred image. Herein, the sublimation printing transfer process relates both to the first step and the second step individually, as well as in combination and sequentially.

### Printed Sublimation Printing Transfer Paper

In the fourth aspect, the present invention relates to a printed sublimation printing transfer paper, comprising the sublimation printing transfer paper of the first aspect and at least one transferable print on the coating.

Typically, the transferable print/image is constituted of inks and/or dyes which are suitable for sublimation printing and is generally arranged as a mirror image of the transferred image. Typically, dyes which are suitable for sublimation printing are deposited from inks which are suitable for sublimation printing. Inks and/or dyes which are suitable for sublimation printing may herein also be referred to as “sublimable”.

The printed sublimation printing transfer paper may be obtained by the first step of the sublimation printing transfer process as disclosed for the third aspect of the present invention and it may be further limited according to any embodiment thereof.

### Method of Preparing Printed Sublimation Printing Transfer Paper

In the fifth aspect, the present invention relates to a method of preparing a printed sublimation printing transfer paper, wherein the method includes a step of ink-jet printing on the coating of the sublimation printing transfer paper of the first aspect.

Preferably, the method yields the printed sublimation printing transfer paper according to the fourth aspect. The method may also include the first step of the sublimation printing transfer process as disclosed for the third aspect of the present invention and it may be further limited according to any embodiment thereof.

### Method of Decorating Printing Substrate

In the sixth aspect, the present invention relates to a method of decorating a printing substrate, in which the transferable print of the printed sublimation printing transfer paper of the fourth aspect is transferred by sublimation onto the printing substrate.

Upon sublimation printing, the transferred image presents on the printing substrate.

The printing substrates are not limited to any particular material or form. Exemplary embodiments include wearable and non-wearable fabrics, such as shirts, covers, tote bags and mousepads; and/or more rigid articles such as ceramic crockery, mobile phone covers, metal plates, tiles, etc. Preferably, the printing substrate is a wearable or a non-wearable fabric, such as a polyester fabric.

The method of decorating a printing substrate may also include the second step of the sublimation printing transfer process as disclosed for the third aspect of the present invention and it may be further limited according to any embodiment thereof.

Based on the foregoing discussion, the following examples, and without wishing to be bound by theory, the inventors have provided a sublimation printing transfer paper that promotes a high transferred image quality, whilst simultaneously exhibiting faster drying times of the transferable prints and being recyclable.

### EXAMPLES

The present invention is exemplified by the following, non-limiting examples.

For ease of reference, herein the term “Example” may be abbreviated as “Ex.” and “Comparative Example” may be abbreviated as “C.Ex.”. For instance, Example A may be abbreviated as Ex. A and Comparative Example A may be abbreviated as C.Ex. A.

The following methods of characterisation were used throughout the examples:
The basis weight was determined according to ISO 536.
The Gurley porosity was determined according to ISO 5636-5.
The Cobb (60 s) value was determined according to ISO 535:2014.
The tackiness was determined according to the Finat FTM2 standard on the sublimation printing transfer paper.

Printing on the sublimation printing transfer paper to yield a sublimation printing transfer paper with a transferable print was carried out by an ink-jet printing process.

The ink dry time was measured as follows. A row of 10 solid colour blocks is printed using black ink. A strip of white copy paper is placed against the first block of the freshly printed ink for 5 s, applying pressure with the finger but avoiding direct contact between finger and the printed ink to avoid moisture and other impurities affecting the result. After 5 s, the strip is pressed against the next block in the row for 5 s again. This process is continued along the row of blocks. When the ink is dried, no transferred print of the black ink appears on the strip of white copy paper. By counting the number of transferred prints on the copy paper strip, the drying time can be recorded with a precision of 5 s. The ink dry time is measured following printing on the transfer paper by an ink-jet printing process.

Sublimation printing was carried out using a sublimation printer on a printing substrate. As an exemplary printing substrate, a white polyester fabric was used.

The resolution (print definition or sharpness) of the transferred image was assessed visually after sublimation printing on the printing substrate.

### Example A—Sublimation Printing Transfer Papers with Partially-Saponified PVOH-Based Coatings Compared to Sublimation Printing Transfer Papers with Thermoplastic-Based Coatings

Example A is aimed at testing the performances of the same coating layer on different paper base substrates.

Comparative Examples A1 and A2 are sublimation printing transfer papers coated with a thermoplastic latex-based coating comprising acrylic latex.

Example A1 was prepared by coating a base substrate of a cellulosic substrate containing fillers having a basis weight of 90 g/m² and a Gurley porosity of 820 s/100 cc. For the partially-saponified PVOH-based coating, partially-saponified PVOH Poval 05-74 from Kuraray was used. The coating was performed by rod coating, and the final coatweight is given in Table A.

Example A2 was prepared in a similar way to Example A1, but a higher basis weight base substrate was used. The Gurley porosity is lower than for Example A1, being 730 s/100 cc, and the final coatweight is given in Table A.

Example A3 was prepared in a similar way to Example A1, but the base substrate does not contain any filler. The Gurley porosity of the base substrate is 55 s/100 cc and the final coatweight is given in Table A.

The basis weight, coatweight, Gurley porosity, and tackiness of the sublimation printing transfer paper are shown in Table A. The dry time and the optical density are shown in Table A.

TABLE A

| | C.Ex. | C. Ex. | Ex. | Ex. | Ex. |
|---|---|---|---|---|---|
| Reference/Property | A1 | A2 | A1 | A2 | A3 |
| Base substrate | | | Base 1 | Base 2 | Base 3 |
| Basis weight of base | 102 | 94 | 90 | 123 | 110 |
| substrate (g/m²) | | | | | |
| Coatweight (g/m²) | | | 2.3 | 2.2 | 2.5 |
| Gurley porosity | 5924 | 6354 | 146712 | 144217 | 60098 |
| of sublimation | | | | | |
| printing transfer paper | | | | | |
| (s/100 cc) | | | | | |
| Tackiness FTM2 | 0.66 | 0.74 | 0.72 | 0.73 | 0.77 |
| (N/25 mm) | | | | | |
| Dry time (s) | 30 | >40 | 15 | 17.5 | 15 |
| Optical density | 7.48 | 7.50 | 7.87 | 7.74 | 7.85 |

The results of Table A show that compared to thermoplastic latex-based coated transfer papers, the sublimation printing transfer papers of the current invention have a significantly faster dry time, leading to an improved processability whilst tackiness can be maintained. Specifically, the faster drying time can enable an improvement of the print definition of the transferable print on the sublimation printing transfer paper. Furthermore, the combination of the improvement of the print definition on the sublimation printing transfer paper and the tack properties of same also improve the print definition of the transferred print on the printing substrate.

### Example B—Saponification Degree and Printing Performance

Comparative Example B1 was prepared by coating a base substrate made of cellulosic fibres without fillers having a basis weight of 110 g/m² and a Gurley porosity of 55 s/100 cc. For the coating, polyvinyl acetate having a degree of saponification of 0% was used. The coating was performed by rod coating, and the final coatweight is given in Table B.

Comparative Example B2, Comparative Example B3, Comparative Example B4, Example B1 and Example B2 were prepared in a similar way to Comparative Example B1, but for the partially-saponified PVOH-based coating different partially-saponified PVOH with different saponification degrees were chosen. The coatings are disclosed in Table B.

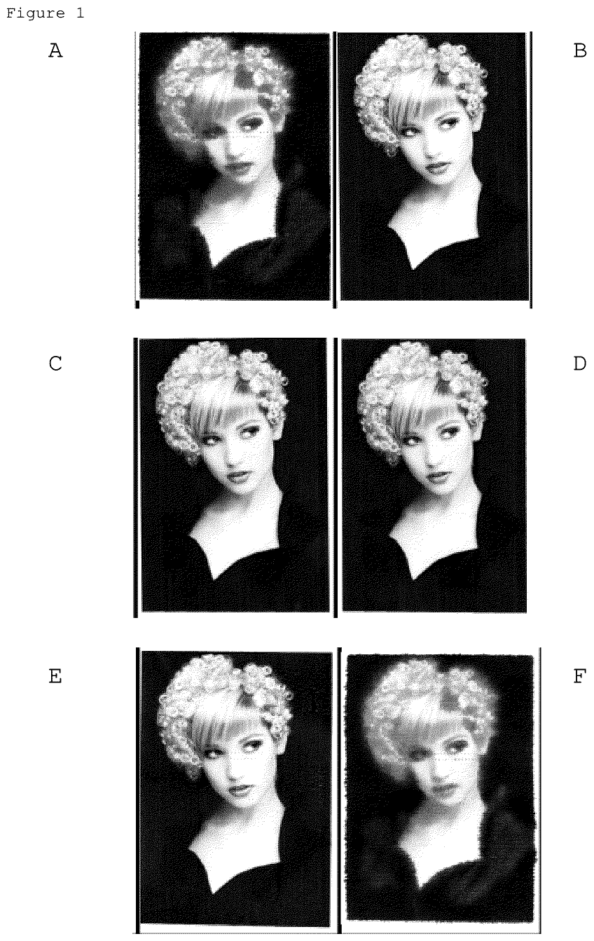

Transferred prints of decorated printing substrates are shown in FIG. 1 as indicated in Table B.

TABLE B

| Example | C. Ex B1 | C. Ex B2 | Ex. B1 | Ex. B2 | C. Ex. B3 | C. Ex. B4 |
|---|---|---|---|---|---|---|
| Saponification | 0 | 30-60 | 73-75 | 80-83 | 87-89 | 98-99 |
| degree (%) | | | | | | |
| Water soluble? | No | No | Yes | Yes | Yes | Yes |
| Coatweight | 4.4 | 4.7 | 3.1 | 3.0 | 3.2 | 3.0 |
| (g/m²) | | | | | | |
| Printing | Poor (ink | Medium | Optimal | Optimal | Medium | Poor (ink |
| resolution | spreading) | | | | | spreaking) |
| | FIG. 1A | FIG. 1B | FIG. 1C | FIG. 1D | FIG. 1E | FIG. 1F |
| Gurley | 7,444 | 147,671 | 87,825 | 85,406 | 114,779 | 38671 |
| porosity s/100 | | | | | | |
| cc | | | | | | |
| Cobb (60 s) | 6.9 | 17.3 | 23.2 | 23.4 | 24.1 | 27.0 |
| value (g/m²) | | | | | | |
| Dry time (s) | >>40 | >40 | 15 | 20 | 30 | >>40 |
| Optical | 7.0 | 6.4 | 7.8 | 7.9 | 7.9 | 8.0 |
| density | | | | | | |
| Ghosting/ | No | No | No | No | No | Yes |
| Duplicate | | | | | | |
| effect | | | | | | |
| Tackiness | 4.26 | 2.26 | 0.82 | 0.74 | 0.70 | 0.00 |
| FTM2 (N/25 mm) | | | | | | |

It has to be noted that a tackiness of above 2 N/25 mm corresponds to a sealing of the sublimation printing transfer paper on the printing substrate, which means that it is very hard to remove the sublimation printing transfer paper from the printing substrate after the transfer of the transferable print without damage of the printing substrate and/or transferred print.

The results of Table B show that the best printing resolution and dry times are observed for Example B1 and Example B2, that is to say for PVOH compounds having a degree of saponification of 74% and 82% respectively. Comparative Example B1 and Comparative Example B2 have relatively low saponification degrees, which result in long drying times, poor optical density transfer upon sublimation printing and a high tack which results in poor image quality during sublimation printing due to difficult peeling-off of the printed sublimation printing transfer paper from the printing substrate after sublimation printing. Comparative Example B3 and Comparative Example B4 on the other hand have relative high saponification degrees, which result in long drying times, as well as insufficient tack causing poor adhesion between the printed sublimation printing transfer paper and the printing substrate during sublimation printing.

### Example C—Saponification Degree and Recyclability Potential

Recyclability assessments were carried out as follows. Sublimation printing transfer papers were repulped in tempered water (between 15 and 25° C.) for 15 minutes. Next, handsheets were formed and subsequently dried at 130° C. for 15 minutes between two blotters. Following the drying step, it was assessed whether the handsheet delaminates from the blotter and whether adhesion areas (herein also known as “stickies”) were present. Delamination and the presence of stickies suggest poor recyclability because the products are not water-soluble. This also means that fibres cannot be reused for conventional paper making

Comparative Example C1 uses the same sublimation printing transfer paper as Comparative Example B1. Comparative Example C2 uses the same sublimation printing transfer paper as Comparative Example B2. Example C1 uses the same sublimation printing transfer paper as Example B1. Example C2 uses the same sublimation printing transfer paper as Example B2. Comparative Example C3 uses the same sublimation printing transfer paper as Comparative Example C3. Comparative Example C4 uses the same sublimation printing transfer paper as Comparative Example B4.

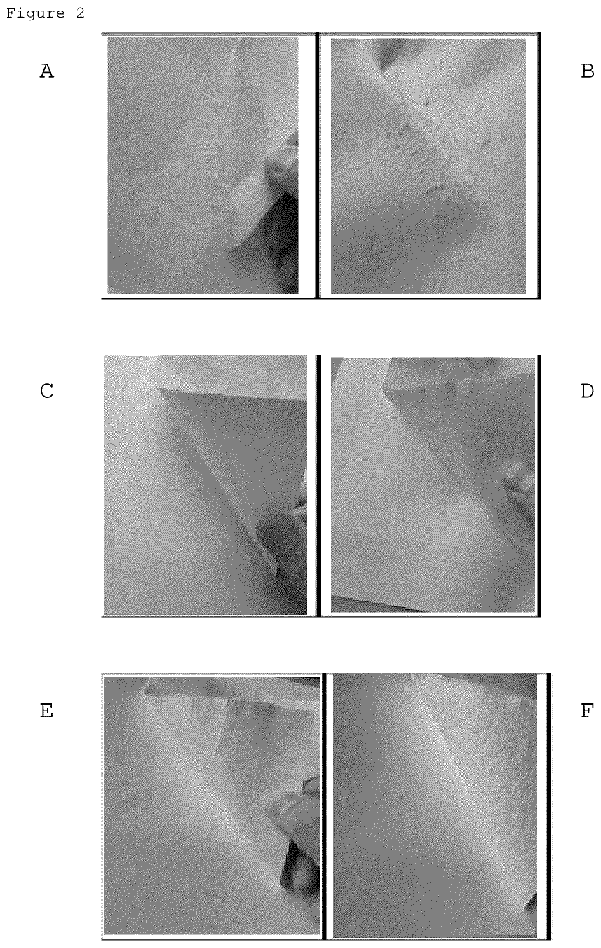

TABLE C

| Example | C. Ex C1 | C. Ex C2 | Ex. C1 | Ex. C1 | C. Ex. C3 | C. Ex. C4 |
|---|---|---|---|---|---|---|
| Saponification | 0 | 30-60 | 73-75 | 80-83 | 87-89 | 98-99 |
| degree (%) | | | | | | |
| Water | No | No | Yes | Yes | Yes | Yes |
| soluble? | | | | | | |
| Recyclability | Stickies | Stickies | No Stickies | No Stickies | No Stickies | No Stickies |
| assessment | Delamination | Delamination | No | No | No | No |
| | | | Delamination | Delamination | Delamination | Delamination |
| | FIG. 2A | FIG. 2B | FIG. 2C | FIG. 2D | FIG. 2E | FIG. 2F |

The results of Table C show that sublimation printing transfer papers with a partially-saponified PVOH-based coating having an insufficiently high saponification degree are non-recyclable because of the occurrence of not water-soluble adhesion areas, or stickies.

The following embodiments are part of the disclosure of the present application. They are not limited to the examples.

### Embodiments

1. A sublimation printing transfer paper comprising a base substrate and a partially-saponified polyvinyl alcohol (PVOH) based coating on one side of said base substrate, wherein the partially-saponified PVOH has a saponification degree of 70 to 85%.
2. The sublimation printing transfer paper of embodiment 1, wherein the partially-saponified PVOH has a saponification degree of 72 to 82%, more preferably 73 to 80%.
3. The sublimation printing transfer paper of embodiment 1 or embodiment 2, wherein the coating, preferably the sublimation printing transfer paper, is substantially latex-free.
4. The sublimation printing transfer paper of any of embodiments 1 to 3, wherein the sublimation printing transfer paper is recyclable according to the EN 13430 standard.
5. The sublimation printing transfer paper of any of embodiments 1 to 4, wherein the sublimation printing transfer paper has one or more of the following properties
   (I) a Gurley porosity between 1,000 s/100 cc and 10,000 s/100 cc, wherein the Gurley porosity is measured according to ISO 5636-5;
   (II) a Cobb (60 s) value of more than 20 g/m², preferably more than 25 g/m², even more preferably of 30 to 60 g/m², wherein the Cobb (60 s) value is measured according to ISO 535:2014;
   (III) a tackiness of 0.4 to 1.2 N/2.5 cm, preferably 0.6 to 0.8 N/2.5 cm, when measured according to the Finat FTM2 standard;
   (IV) a basis weight of 60 to 130 g/m², preferably of 80 to 110 g/m².
6. The sublimation printing transfer paper of any of embodiments 1 to 5, wherein the base substrate comprises 80 to 100 wt % natural cellulosic fibres and 0 to 20 wt % filler, based on the weight of the base substrate optionally wherein the filler is one or more selected from talc, calcium carbonate, kaolin clay, titanium dioxide, and mixtures thereof.
7. The sublimation printing transfer paper of any of embodiments 1 to 6, wherein the base substrate has one or more of the following properties
   (i) a Gurley porosity below 1000 s/100 cc, preferably below 500 s/100 cc, and more preferably below 100 s/100 cc, wherein the Gurley porosity is measured according to ISO 5636-5; and
   (ii) a Cobb (60 s) value of more than 20 g/m², preferably more than 25 g/m², even more preferably between 30 and 60 g/m², wherein the Cobb (60 s) value is measured according to ISO 535:2014.
8. The sublimation printing transfer paper of any of embodiments 1 to 7, wherein the partially-saponified PVOH is contained in the coating in an amount of 60 to 100 wt %, based on the total weight of the coating.
9. The sublimation printing transfer paper of any of embodiments 1 to 8, wherein the coating contains 0 to 40 wt % of co-binders, based on the total weight of the coating, preferably wherein the co-binders are selected from starch and derivatives thereof, fully-saponified PVOH, carboxymethyl cellulose (CMC) and other cellulosic derivates, alginates, latexes and mixtures thereof.
10. The sublimation printing transfer paper of any of embodiments 1 to 9, wherein the coating contains 0 to 20 wt % pigments, based on the total weight of the coating, preferably wherein the pigments are selected from kaolin clay, calcium carbonate, silica, talc, titanium dioxide, and mixtures thereof.
11. The sublimation printing transfer paper of any of embodiments 1 to 10, wherein the coating has a coatweight on the side of the base substrate of 1 to 10 g/m², preferably of 1 to 5 g/m², more preferably of 2 to 3 g/m² by dry weight.
12. A method of preparing the sublimation printing transfer paper of any of embodiments 1 to 11, wherein the method comprises applying the coating onto the base substrate by online or offline coating methods, such as size-press, metering size-press, twin coating, metering coating, rod coating, blade coating, airblade coating, curtain coating, film press, heliogravure, spray coating, rotogravure, or transfer coating.
13. Use of the sublimation printing transfer paper of any of embodiments 1 to 11 in a sublimation printing transfer process.
14. A printed sublimation printing transfer paper, comprising the sublimation printing transfer paper of any of embodiments 1 to 11 and at least one transferable print on the coating.
15. A method of preparing a printed sublimation printing transfer paper, wherein the method includes a step of ink-jet printing on the coating of the sublimation printing transfer paper of embodiments 1 to 11.
16. A method of decorating a printing substrate, in which the transferable print of the printed sublimation printing transfer paper of embodiment 14 is transferred by sublimation onto the printing substrate.

1. A sublimation printing transfer paper comprising a base substrate and a partially-saponified polyvinyl alcohol (PVOH) based coating on one side of said base substrate, wherein the partially-saponified PVOH has a saponification degree of 70 to 85%, and wherein the partially-saponified PVOH is contained in the coating in an amount of 72 to 100 wt %.

2. The sublimation printing transfer paper of claim 1, wherein the partially-saponified PVOH has a saponification degree of 72 to 82%, more preferably 73 to 80%.

3. The sublimation printing transfer paper of claim 1, wherein the coating, preferably the sublimation printing transfer paper, is substantially latex-free.

4. The sublimation printing transfer paper of claim 1, wherein the sublimation printing transfer paper is recyclable according to the EN 13430 standard.

5. The sublimation printing transfer paper of claim 1, wherein the sublimation printing transfer paper has one or more of the following properties
(I) a Gurley porosity between 1,000 s/100 cc and 10,000 s/100 cc, wherein the Gurley porosity is measured according to ISO 5636-5;
(II) a Cobb (60 s) value of more than 20 g/m², preferably more than 25 g/m², even more preferably of 30 to 60 g/m², wherein the Cobb (60 s) value is measured according to ISO 535:2014;
(III) a tackiness of 0.4 to 1.2 N/2.5 cm, preferably 0.6 to 0.8 N/2.5 cm, when measured according to the Finat FTM2 standard;
(IV) a basis weight of 60 to 130 g/m², preferably of 80 to 110 g/m².

6. The sublimation printing transfer paper of claim 1, wherein the base substrate comprises 80 to 100 wt % natural cellulosic fibres and 0 to 20 wt % filler, based on the weight of the base substrate optionally wherein the filler is one or more selected from talc, calcium carbonate, kaolin clay, titanium dioxide, and mixtures thereof.

7. The sublimation printing transfer paper of claim 1, wherein the base substrate has one or more of the following properties
(i) a Gurley porosity below 1000 s/100 cc, preferably below 500 s/100 cc, and more preferably below 100 s/100 cc, wherein the Gurley porosity is measured according to ISO 5636-5; and
(ii) a Cobb (60 s) value of more than 20 g/m², preferably more than 25 g/m², even more preferably between 30 and 60 g/m², wherein the Cobb (60 s) value is measured according to ISO 535:2014.

8. The sublimation printing transfer paper of claim 1, wherein the partially-saponified PVOH is contained in the coating in an amount of 60 to 100 wt %, based on the total weight of the coating.

9. The sublimation printing transfer paper of claim 1, wherein the coating contains 0 to 40 wt % of co-binders, based on the total weight of the coating, preferably wherein the co-binders are selected from starch and derivatives thereof, fully-saponified PVOH, carboxymethyl cellulose (CMC) and other cellulosic derivates, alginates, latexes and mixtures thereof.

10. The sublimation printing transfer paper of claim 1, wherein the coating contains 0 to 20 wt % pigments, based on the total weight of the coating, preferably wherein the pigments are selected from kaolin clay, calcium carbonate, silica, talc, titanium dioxide, and mixtures thereof.

11. The sublimation printing transfer paper of claim 1, wherein the coating has a coatweight on the side of the base substrate of 1 to 10 g/m², preferably of 1 to 5 g/m², more preferably of 2 to 3 g/m² by dry weight.

12. A method of preparing the sublimation printing transfer paper of claim 1, wherein the method comprises applying the coating onto the base substrate by online or offline coating methods, such as size-press, metering size-press, twin coating, metering coating, rod coating, blade coating, airblade coating, curtain coating, film press, heliogravure, spray coating, rotogravure, or transfer coating.

13. Use of the sublimation printing transfer paper of claim 1 in a sublimation printing transfer process.

14. A printed sublimation printing transfer paper, comprising the sublimation printing transfer paper of claim 1 and at least one transferable print on the coating.

15. A method of preparing a printed sublimation printing transfer paper, wherein the method includes a step of ink-jet printing on the coating of the sublimation printing transfer paper of claim 1.

16. A method of decorating a printing substrate, in which the transferable print of the printed sublimation printing transfer paper of claim 14 is transferred by sublimation onto the printing substrate.
